(19) United States
(12) Patent Application Publication
(10) Pub. No.: US 2010/0230925 A1
(43) Pub. Date: Sep. 16, 2010

(54) Four Wheel Human Powered Striding Cycle

(76) Inventor: Todd Thielbar, Land O Lakes, FL (US)

Correspondence Address: Todd Herbert Thielbar, 23517 Vistamar Court, Lando Lakes, FL, 34639, US

(21) Appl. No.: 12/358,330

(22) Filed: Mar. 11, 2009

(51) Int. Cl. B62M 1/04; B62K 5/00

(52) U.S. Cl. 280/221; 280/252; 280/282; 280/267; 482/61; 280/288.4

(57) ABSTRACT

A four wheeled, human-powered, striding cycle that uses the stepping and striding motion of the human legs to propel a rider forward. Two separate and dependent foot pedals are moved fore and aft along a concaved arc segment. The motion simulates the natural stepping and striding motion of a running human. A standing human steps on a pedal, then moves it down and aft in a striding motion. As one pedal is moved aft, the other pedal moves forward in a reciprocating fashion. A cable and pulley system connects each pedal with its respective rear wheel. Pedal motion aft applies torque to its respective drive shaft which in turn rotates its respective drive wheel. Pedal motion forward also provides torque to the opposing drive shaft creating additional torque for the opposite wheel. Forward motion begins when force is exerted down and aft on each pedal by the stepping and striding motion of the human leg. The downward and repetitive stepping and striding motion provides the rider with forward motion and an intense aerobic exercise.

### RELATED APPLICATIONS

This application claims no priority from any prior claim.

### BACKGROUND OF THE INVENTION

1. Field of the Invention

The present invention relates generally to Human-Powered Land Vehicles. More specifically, the invention relates to a four-wheeled transportation device with a reciprocating power application.

2. The Relevant Technology

The human desire to exercise outdoors while cycling is a prevalent endeavor among all ages. Cycling outdoors provides the rider with, fresh air, sunshine, nature, and enjoyment of the surrounding scenery. Cycling outdoors is a way for people to enjoy these benefits while achieving transportation.

Running is a popular outdoor exercise that millions of people undertake. Unfortunately, there are two major problems associated with running. Running creates large impact forces on the human body. A runner's feet, legs, knees, and back take large impact forces when the feet contact the ground. A large number of people do not run because their bodies cannot take the high impact forces. The present invention alleviates these problems by duplicating the runners stride with pedals on a smooth arc shaped rail. The runners stride is further converted into cyclic mechanical energy without causing the impact forces associated with running.

Bicycling is an outdoor exercise that provides exercise and transportation. Unfortunately, recreational bicycling provides a lackluster aerobic workout because most of the exercise occurs in the seated position. Additionally, the pedaling system of a bicycle is based on circular motion which is not a totally natural motion for the human leg. The circular motion of a bicycle crank and pedal does not obtain the mechanical benefits of natural running human. The present invention is a standing only exercise that converts the runners stride into useful cyclic mechanical energy while propelling a four-wheeled cycle.

There are found in the prior art various examples self propelled elliptical cycles. U.S. Pat. No. 5,591,107 by Rodgers and U.S. Pat. App. No. 20080116655 by Martinez use drives with the feet moving in an elliptical path. Elliptical path drive mechanisms do not provide the torque available to achieve high cycle speeds. In addition, the elliptical path although comfortable in some cases, does not simulate the natural stride of a running human and thus is difficult to use when attempting to run fast.

There are also examples of stepping systems used to propel cycles. U.S. Pat. No. 6,648.355 by Ridenhour is an example of a stepping cycle in which forward motion is obtained by stepping only. One drawback of this invention is it does not provide a great deal of torque during propulsion and thus high speeds are difficult to achieve. Additionally, the stroke is restricted to an up and down motion and does not simulate a striding human.

Other examples of self propelled cycles include the tread-mill cycles. An example includes U.S. Pat. No. 6,511,087 by Fong in which a tread-mill is walked upon to rotate drive wheels. Tread-mill designs have little torque supplied by the rider and thus slow speeds. The tread-mill designs also do not support the bottom of the foot as force is applied. This high stress on the forward ball of the foot during propulsion can create foot injuries. Finally, the tread-mill cycles operate with a horizontal platform and do not simulate the natural striding motion of the human leg during running.

The present invention offers many advantages over any prior art. The first advantage is cardiovascular and aerobic exercise. None of the prior inventions offer a cycle capable of delivering the intense cardiovascular and aerobic workout while simultaneously standing and cycling. Additionally, no prior art simulates the natural stride of a running human and converts that motion efficiently into forward velocity. Another advantage over the prior art is the ability of the returning pedal to provide additional energy to assist in forward motion when returning the pedal to the forward position. This is done by having a dependent and connected reciprocating pedal system. An additional advantage over the prior art is the use of a four wheel system and a standing cyclist. This creates a stable platform for the rider to stand while cycling. Unfortunately, none of the previously invented cycle technologies have been able to replicate the natural stride of the human leg during running and convert that motion into useful cyclic energy.

### BRIEF SUMMARY OF THE INVENTION

A major goal of the present invention is to maximize the power benefits of the human leg in running motion and to convert that motion into useable and efficient forward cycling motion. The motion begins with a human first stepping, then striding, moving pedals fore and aft and down an arc ed platform supported by elevated rails. Each pedal is connected to a rear drive wheel with a dedicated cable and pulley system.

Another goal of the present invention is to provide an intense aerobic and cardiovascular workout for a runner while obtaining transportation. The rider must use significant effort to obtain forward motion. Because the striding cycle uses the most efficient and natural motion of a running human, minimal impact forces to the human body are created. The invention is also designed to train runners for sprinting, cross-country, and marathons without the foot and joint stresses prevalent in speed and distance training. Each pedal's upper surface is semi-horizontal at the top of the arc. As the pedal is moved aft, the upper surface angle duplicates the natural position of the foot as it moves to the rear of the stride.

Stability for a standing human while operating this invention is of utmost importance. Experimentation shows that 4 wheels are best. The striding cycle is stable for the rider at rest and in motion. The cycle can be easily mounted from either side. The rider simply puts a foot on each pedal and places a hand on each steering bar. Next, the rider moves the pedals fore and aft as in a reciprocating fashion. Certain models may contain multiple gears to aid in pedaling on hills. Braking is accomplished with handbrakes, one on each steering bar. Each handbrake controls brake calipers on the wheels.

The present invention eliminates a sore buttocks during operation which is common during bicycling. The striding cycle has no seat, so the rider must stand throughout the operation. Not allowing the rider to rest on a seat, or use it as a crutch, allows the exerciser a quality lower body workout. Operating the striding cycle works the gluteus, quadriceps, hamstrings, knees, calves, ankles, and feet.

### BRIEF DESCRIPTION OF THE DRAWINGS

To further clarify the benefits of the present invention, drawings are shown that detail the embodiments of the invention. The drawings depict typical embodiments and are not to be considered limiting in scope.

FIG. 1 is a side view of the present invention depicting the forward steering assemblies, the elevated frame, the skate pedals, the drive system, and the rear cycle wheels.

FIG. 2 depicts the top view of the skate-pedal return system. The view also depicts twenty-four roller bearings (not a limiting number) in which the drive cables travel under. The two outer cables are the drive cables. The two inner cables are the pedal return cables.

FIG. 3 depicts the primary view of the cross sectional of the elevated frame, a drive cable, and a pedal return cable. It also shows the end view of the skate-pedal and roller.

FIG. 4 depicts the side view of cable-drive system. The forward cable can be seen connected to the skate-pedal. The cable can further be seen running under the first of seven roller bearings (not a restricting number). The cable is further shown running around three small sprockets before reaching the main drive sprocket. Finally, the main drive sprocket is shown connected to the rear cycle wheel with a chain or belt.

FIG. 5 depicts a perspective view of the lower and upper frame assemblies. The lower beams are shown supporting four vertical frames. The four frames are shown having a steeper ramp in the front and a less steep ramp in the back. Grooves are shown in the upper portions of the frames which provide a track into which the skate-pedal wheels can travel.

FIG. 6 depicts the top view of the lower frame assembly. Two steering assemblies with small bicycle wheels can be seen attached to the forward frame assembly. Two rear bicycle wheels can be seen supported by the rear frame assembly. Two main drive shafts with sprockets can also be seen connected to two rear cycle wheels.

FIG. 7 depicts the cross sectional view of the alternate vertical rail and cable pulley system. This secondary design of the vertical structure is a more cost effective design that reduces production costs. This view shows the cross section of two rails and the upper and lower roller wheels which ride on those rails. It also shows the left drive cable which leads to the left wheel and the right pedal return cable which connects to the opposite pedal.

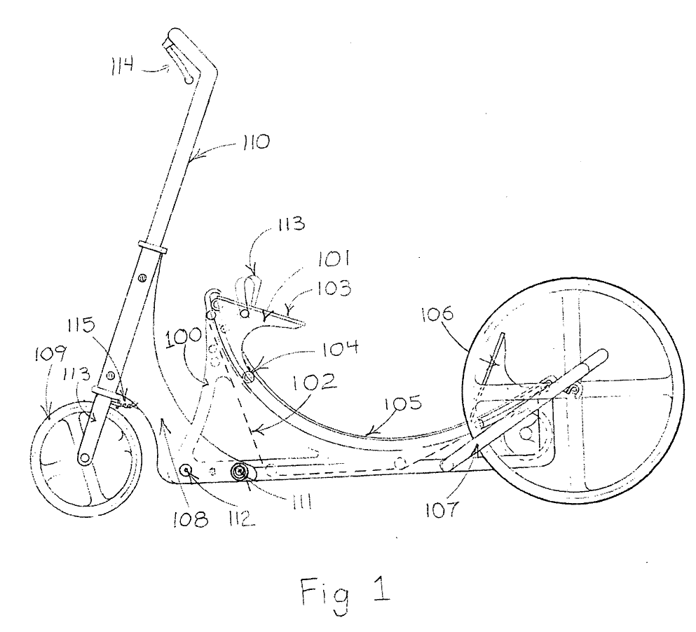

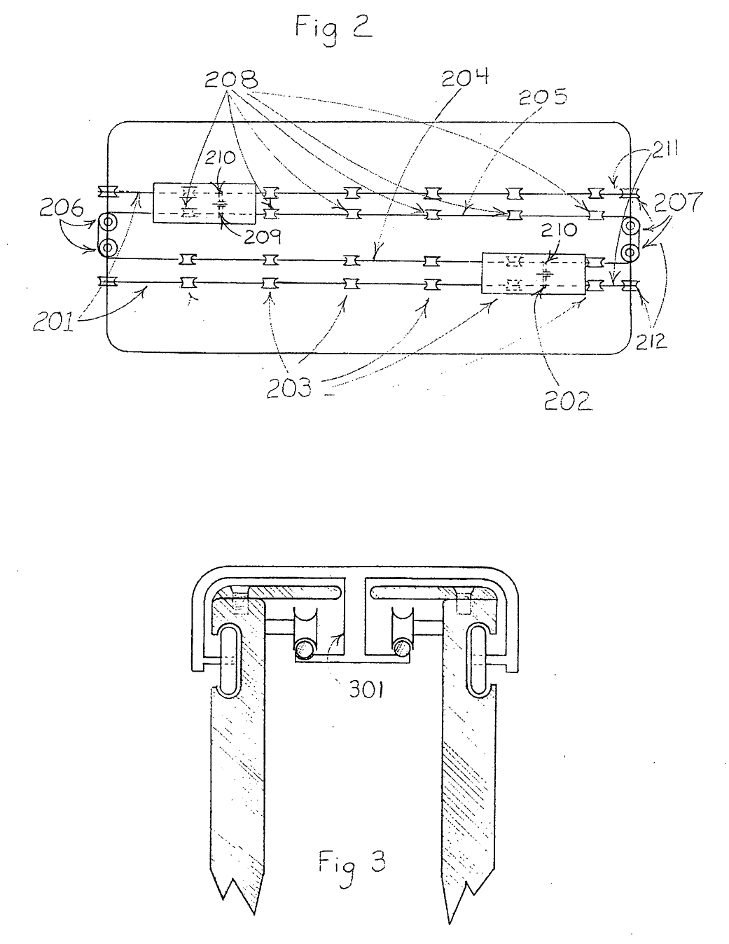

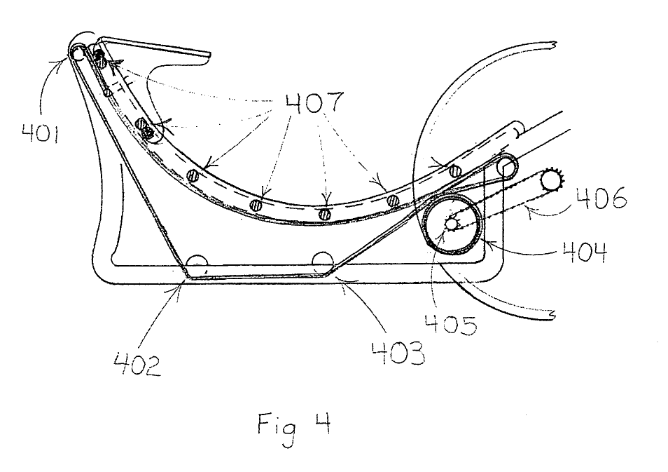

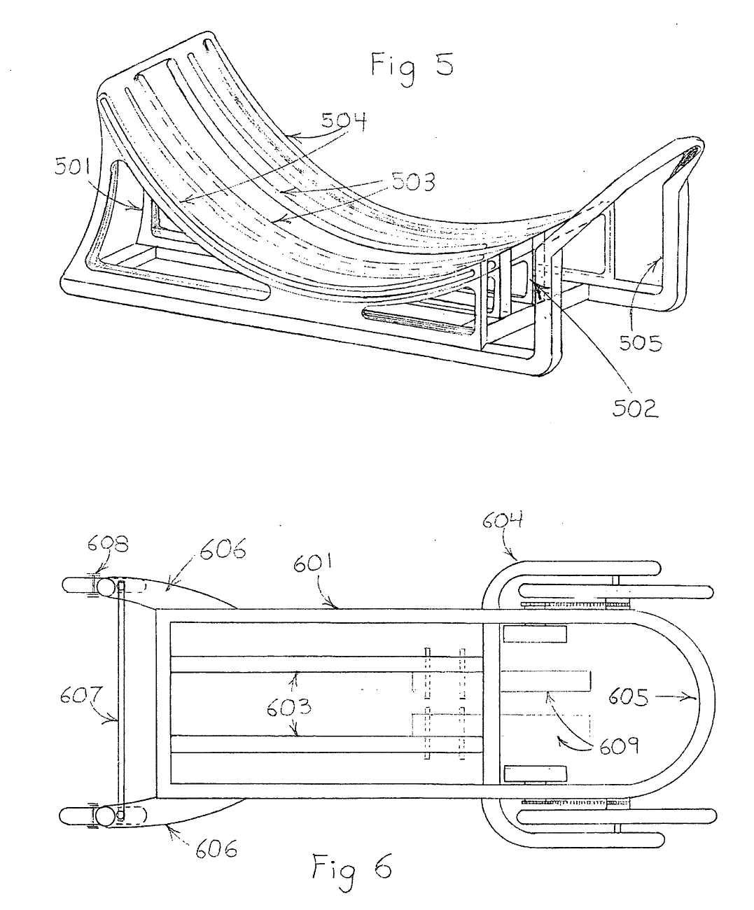

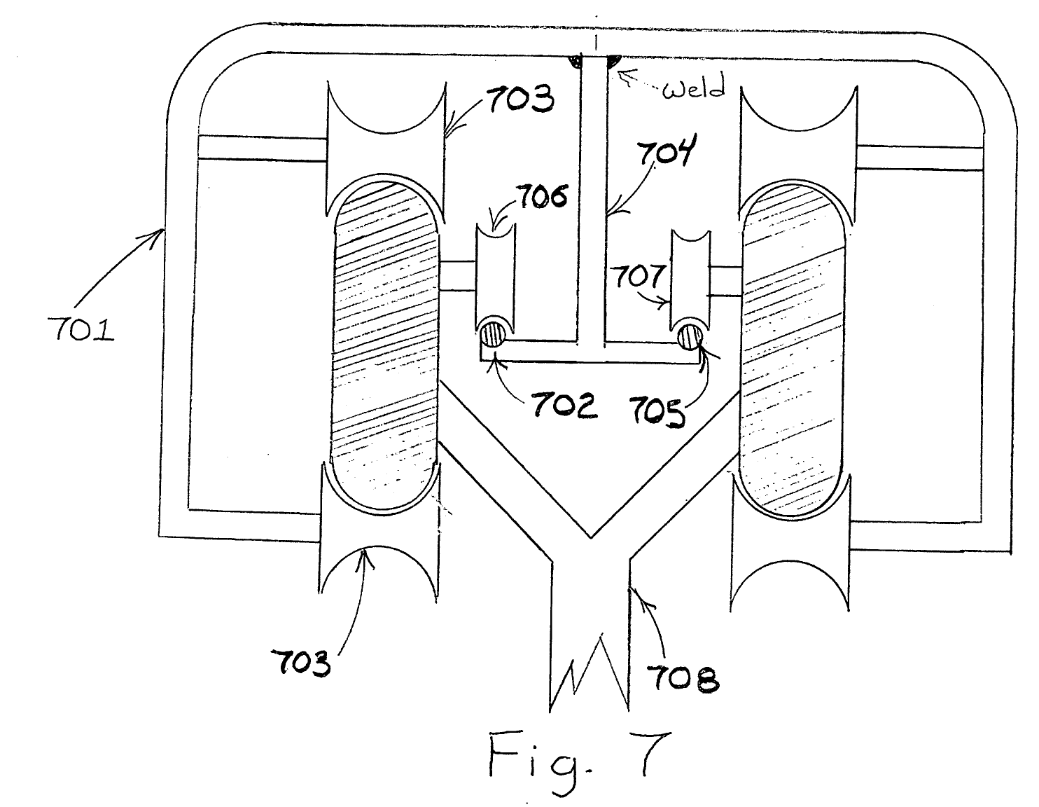

### DESCRIPTION OF THE PREFERRED EMBODIMENT

### I. Introduction

The invention is a four wheeled striding cycle that converts the natural striding motion of a running human into forward cycling motion. The embodiment includes elevated frame assemblies 100; each rail with the upper surface in the shape of a parabolic arc, being steeper in the front and less steep in the back simulating the natural stepping and striding motion of a human leg. Two skate-pedals 101, 106, 701, each with multiple wheels roll along the upper surface of a frame or rail. Each skate pedal is connected to its respective rear drive axle with a cable 102, 702. The standing rider uses his/her legs to move the pedals down and up the arc creating forward motion.

In circular rotational mechanics such as a common bicycle crank, the power stroke occurs on the downward stroke. A bicycle pedal, at the end of a bicycle crank, moves in a circular motion and provides a less efficient means of propulsion because the rotation is an unnatural motion for the human leg. Additionally, a bicycle pedal rotates around an axle which is unstable for the human foot. Body range of motion and kinesthesia shows that the human leg provides more power on the downward stroke using weight and gravity. In addition, a stable, high, and flat stepping surface 103 uses gravity more efficiently to propel a cycle. Additional force is obtained by the rider moving the pedal farther aft along the arc until it reaches the end. As the rider steps forward and returns the pedal to the top of the arc, additional force is applied to the pedal, creating additional forward motion. A strap on the upper side of each skate-pedal 113 keeps the foot in place allowing for the pedal to be pulled forward. The present invention uses two pedals 101, 106 each containing multiple wheels with a standing surface tilted slightly down in the full upright position 103. Small, soft wheels using low friction bearings are connected to the base of each pedal 104, 703. Each of the wheels located under each skate-pedal travel down and up the arc segment, steeper in the front and less steep in the back 105.

The pedal drive system is a cable-pulley, drive axle, and chain/belt drive combination. A cable/rope is connected to a fin 301, 704 beneath each pedal. As the pedal is moved down and aft, the cable is pulled under a series of pulleys 203, 407, 706, 707. The pulleys are positioned in equal lengths along the arc segment 203. This allows the travel length of the cable to coincide with the length traveled by the skate pedal. The cable is further pulled around and under a series of three larger pulleys 401, 402, 403 the first located at the forward top of the arc, the second located directly below on the frame, and the third located midway down the length of frame. The end point of the cable is a large sprocket placed on a drive shaft 405. The sprocket diameter 404 is large enough to supply enough torque to the drive shaft to allow the rider forward motion at bicycle speeds. Each of the two large sprockets, one on the left drive sprocket and one on the right are grooved to allow the cable to properly wind around the sprocket. A second drive-return cable is connected to the rear of each skate-pedal 202, 705 and the main drive sprocket. The rear cables run under the same series of drive roller bearings 203, 706 as the forward drive cables 201, 702, and finally around the left and right rear drive pulleys 212, before reaching the drive shaft sprocket. This cable assists in returning the drive cable to its starting position after a complete stride is completed. Ultimately, movement of the skate-pedals from the extreme top of the ramp, to the extreme rear of the ramp rotates the drive shaft. On the opposite end of the drive shaft is a smaller diameter chain sprocket 405. The chain sprocket is connected directly to its respective drive wheel via a chain 406.

A cable and pulley system allows each skate pedal to move in a reciprocating fashion. As a pedal is moved backward, the opposing pedal is pulled forward. The return system is accomplished using two separate cables one forward and one aft 204, 205. The forward return cable is connected to the bottom fin of each skate-pedal 209, 210. This forward cable runs under a series of roller bearings situated under each elevated parabolic arc rail 208. The forward cable further runs around two horizontal pulleys 206. The aft cable similarly runs around a set of two horizontal pulleys 207. The rear cable segments are also connected to the bottom fins of each skate pedal 209, 210. This cable and pulley system allows a complete return of the opposing pedal.

The rectangular frame-chassis provides the structural integrity for the present invention 601. It is a box frame design with lateral dimensions of approximately 2 feet by 4 feet, not including the removable steering columns 602. The width of the frame is important for two reasons. The striding cycle is designed to be operated on a sidewalk with enough room to pass a walking bystander. Secondly, the cycle is designed to be easily transported in the rear of a mid-sized vehicle. The material used is a lightweight aluminum alloy or a similar metal making the striding cycle easy to lift and move. The frame may also contain two center beams 603 which run down the length of the frame. These center beams are designed to support two inner vertical frames 501, 502, which in turn support the upper rail structure 503. The two outer rails similarly support two vertical frames which also support the upper rail structure 503. Other embodiments may include a vertical frame structure 708 that supports tubular rails in which skate-pedals may roll on. The two outer beams 601, 505 continue back and are angled upward to support the inner axle of the rear wheels. In addition, the rails wrap around the inner rear of the frame 605 to be used by a human for lifting. A dual support arm structure 604 is used to support the outer wheel axles. This dual support arm rises to an angle of approximately thirty-five degrees and provides the outer support for both outside cycle wheels.

Connected to the forward frame section are two separate steering assemblies 108, 606. The assemblies each contain a fork 113, to hold a small cycle wheel 109, and a telescoping steering bar 110 to be adjusted for the height of the rider. The steering assemblies can be rotated around a pivot bolt 111 to the horizontal position by removing a pin 112. This allows for easy transportation. Each of the steering assemblies is connected to one another with a steering tie bar 607. This allows each steering column to turn simultaneously with the other. Steering can be accomplished with one or both hands. A spring is attached between each fork and steering assembly to maintain rigid and stable steering.

Braking is accomplished with the use of hand brakes 114, one on each handle. Front calipers 608 or disk brakes may be used on each front wheel. A rear set of caliper brakes or similar set-up may also be used for rear wheel braking.

A removable frame support structure is provided for future external power applications. This frame could support a variety of engines; gas, electric, solar, pneumatic etc.

1.) A four wheeled, human-powered, striding cycle using a unique parabolic arc, steeper in the front and less steep in the back to efficiently convert the striding motion of a running human into a useful means to propel a 4-wheeled cycle at moderate speeds, providing a rider physical training and transportation; consisting of a cyclist having two feet and standing moving skate pedals down and along a concaved arc segment in a reciprocating manner; the concaved arc segment being steeper in the front, taking advantage of the gravitational advantage of a stepping human and less steep in the back taking mechanical advantage of the striding motion of a human leg while running; each pedal connected to its respective rear wheel via a cable and drive axle system; each pedal further being connected to each other with two cables and a series of pulleys allowing the pedals to be moved in a reciprocating manner; the standing cyclist applying a downward and aft force to the pedal causing its respective rear wheel to rotate while simultaneously returning the opposing pedal to its starting position with additional force being supplied to the opposing wheel as each pedal is moved forward; the cyclist creates forward motion while striding.

2.) A skate pedal drive system that converts pedal motion into a useable rotational force that efficiently turns two rear cycle wheels, propelling a cyclist; consisting of a left and right set of pulleys, one for each pedal to include: an upper pulley, one or two lower pulleys, multiple smaller pulleys attached to the bottom of each left and right arc segment, and two central drive sprockets each connected to two rear cycle wheels; two drive cables, one for the left pedal and one for the right pedal are drawn under a series of smaller pulleys; the cable is further drawn around larger upper and lower pulleys before being connected to two independent central drive sprockets which are separately connected to respective cycle wheels via a chain, belt, or cable.

3.) The skate-pedal drive system of claim 2 further comprising a skate-pedal return system using two separate cables for each pedal, one forward and one aft connected to the front and back of each pedal; each cable drawn under a series of small pulleys located under each arc rail segment allowing the cable to travel the equivalent distance traveled by the pedal then around two forward and two rear pulleys allowing each pedal to be moved fore and aft as in a reciprocating fashion; as the rider moves one pedal aft, he/she simultaneously pulls the other pedal forward and vice-versa; forward pedal motion further supplying additional torque and forward rotation to the opposing drive wheel.

4.) The skate-pedal drive system of claim 2 further comprising of two pedals, each containing wheels which secure it to the track or rail, allowing movement down and up an inclined arc segment; each pedal further comprising of a flat upper foot surface which remains nearly horizontal at its most forward and highest point; an adjustable strap further located on the upper surface of each pedal to secure the human foot; each pedal further comprising of a lower fin in the shape of an upside down “T” used to connect each pedal to four cables, two drive cable and two pedal return cables.

5.) A stable four-wheeled (non limiting) chassis and frame designed for a vertically standing human comprising:
a. a rectangular base frame chassis
b. two unique steering column assemblies which allow comfortable steering with one or both hands
c. support rails that provide elevation for the skate pedals, each with an identical arc shape having a steeper front and a less steep rear
d. adjustable lifting stilts used to raise the cycle for indoor use
e. a frame attachment to support a power supply for future adaptations.

6.) The chassis and frame design of claim 5 further comprising of a rectangular base frame narrow enough for the cycle to be used on a sidewalk and long enough to contain the stride of a running human; beams, each running lengthwise and providing support for the vertical arc structure and steering assembly mounting; two outer rear support arms which support the outer axles of both rear bicycle wheels; two rear inner support arms used to support the inner axles of both rear bicycle wheels and a lifting bar on the rear of the frame.

7. The chassis and frame design of claim 5 further comprising of two forward steering assembles with telescoping handle bars, separated by a shoulders width allowing a rider to lean forward through the bars; two steering assemblies being rotatable and attached to the frame chassis; two separate forks, one under each steering assembly and each supporting its own cycle wheel.

8. The chassis and frame design of claim 5 further comprising rails with a distinctive concave shape having a steeper front and less steep rear with a tubular or grooved track to hold the skate-pedal in place.

9. The chassis and frame design of claim 5 further comprising of lifting stilts used to raise the cycle for indoor use; the stilts being adjustable in height to allow the rear cycle wheels to turn freely.

10. The chassis and frame design of claim 5 further encompassing a removable frame attachment at the rear of the cycle to be used as a support for future external motor applications i.e. gas, battery, pneumatic, solar-electric, etc.
